(19) United States
(12) Patent Application Publication
(10) Pub. No.: US 2004/0164982 A1
(43) Pub. Date: Aug. 26, 2004

(54) Method and apparatus for editing three-dimensional model, and computer readable medium

(75) Inventors: Koichi Fuijiwara, Otsu-shi (JP); Shinichi Horita, Osaka (JP)

Correspondence Address: MCDERMOTT, WILL & EMERY, 600 13th Street, N.W., WASHINGTON, DC, 20005-3096, US

(73) Assignee: MINOLTA CO., LTD.

(21) Appl. No.: 10/455,320

(22) Filed: Jun. 6, 2003

(30) Foreign Application Priority Data
Feb. 24, 2003 (JP) 2003-046357

(51) Int. Cl. G06T 15/00

(52) U.S. Cl. 345/419

(57) ABSTRACT

A method and a device for editing a three-dimensional model are provided which facilitate processing and an operation for mapping in editing the three-dimensional model so as to edit the three-dimensional model easily. The method for editing a three-dimensional model in which texture images are mapped onto three-dimensional data including polygons includes extracting a vertex located at a seam portion between the texture images out of vertexes of the polygons as a seam vertex, storing the extracted seam vertexes in a vertex extraction list, and changing the vertexes other than the seam vertexes to modify the three-dimensional data without changing the seam vertexes stored in the vertex extraction list. With respect to the modified three-dimensional data, the original texture images are mapped.

This application is based on Japanese Patent Application No. 2003-046357 filed on Feb. 24, 2003, the contents of which are hereby incorporated by reference.

### BACKGROUND OF THE INVENTION

1. Field of the Invention

The present invention relates to a method and apparatus for editing a three-dimensional model, and a computer readable medium.

2. Description of the Prior Art

Conventionally, texture images are mapped onto three-dimensional data including polygons to create a three-dimensional model. For example, a non-contact three-dimensional shape input device is used to obtain three-dimensional data of an object and, at the same time, the entire surface of the object is photographed to obtain a plurality of texture images. Then, the plural texture images are mapped onto the three-dimensional data. On this occasion, the texture images are pasted onto the data carefully without hurry in such a manner to prevent texture image seams from being conspicuous. Thus, a realistic three-dimensional model of the object is obtained. The three-dimensional model obtained by the method mentioned above is often used in the fields of computer graphics, industrial designs and presentations on websites in recent years.

There are situations where the resulting three-dimensional model is modified or transformed, i.e., edited. For example, the number of vertexes of polygons forming three-dimensional data may be reduced, some of the vertexes may be moved or a vertex may be generated due to subdivision of the polygon. More specifically, there is a case where quantity of data is reduced in order to use a three-dimensional model created for websites in a cell phone. In this case, the number of vertexes is reduced to a fraction of the original number, for example, and texture images are mapped onto the reduced three-dimensional data anew, i.e., texture images are reallocated.

In this reallocation also, careful processing is required to prevent texture image seams from being conspicuous and unnatural, as described above.

As a method for deciding a texture image to be allocated to each polygon, there is proposed a method of calculating an evaluation value based on normal vector to each polygon and line-of-sight information included in a texture image for decision, a method of selecting a texture image having the highest resolution with respect to each polygon for decision or the like. If only a computer performs such processing, the mapping often proves to be unsatisfactory in respect of appearance. For example, a seam may so appear that the seam crosses a characteristic area of texture images. In this case, a user is required to reallocate the texture images by manual operation, thereby causing a heavy burden for the user.

Further, a blending process (a mixing process) of plural images is often conducted for a texture image seam portion. Reattempt of mapping entails this time-consuming blending process.

Therefore, a process and an operation for the mapping require much time and labor; thereby causing considerable time and labor for editing a three-dimensional model.

### SUMMARY OF THE INVENTION

An object of the present invention is to facilitate a process and an operation for mapping in editing a three-dimensional model so as to edit the three-dimensional model easily.

According to one aspect of the present invention, a method for editing a three-dimensional model in which texture images are mapped onto three-dimensional data including polygons is provided. The method includes the steps of extracting a vertex located at a seam portion between the texture images out of vertexes of the polygons as a seam vertex, storing the extracted seam vertexes in a vertex extraction list, and changing the vertexes other than the seam vertexes to modify the three-dimensional data without changing the seam vertexes stored in the vertex extraction list.

With respect to the modified three-dimensional data, the original texture images are mapped.

According to another aspect of the present invention, the method further includes the steps of preparing an adjacent polygon list for indicating the polygons neighboring each of the vertexes forming the polygons, and preparing a polygon structure list for indicating the vertexes forming each of the polygons and the texture image used in each of the polygons, wherein in the step of extracting the vertex, the texture image used in each of the polygons neighboring each of the vertexes is checked with reference to the adjacent polygon list and the polygon structure list and when the plural texture images are used for one vertex, the vertex is extracted as the seam vertex.

The change of the vertexes includes, for example, movement of one or more of the vertexes, deletion or reduction of one or more of the vertexes, and generation of new vertexes due to subdivision of the polygons.

These and other characteristics and objects of the present invention will become more apparent by the following descriptions of embodiments with reference to drawings.

### BRIEF DESCRIPTION OF THE DRAWING

FIG. 1 is a block diagram showing an editing apparatus of a three-dimensional model according to an embodiment of the present invention.

FIG. 2 shows three-dimensional data and images for mapping.

FIG. 3 shows an example of a generated three-dimensional model.

FIG. 4 shows an example of data of a seam portion of the three-dimensional model.

FIG. 5 is a table showing an example of a polygon structure list of the three-dimensional model.

FIG. 6 is a table showing an example of an adjacent polygon list.

FIG. 7 is a table showing an example of a vertex extraction list.

FIG. 8 shows an example of data of a seam portion of the three-dimensional model when a vertex is deleted.

FIG. 9 is a flowchart showing the entire edit processing in the editing apparatus.

### DESCRIPTION OF THE PREFERRED EMBODIMENTS

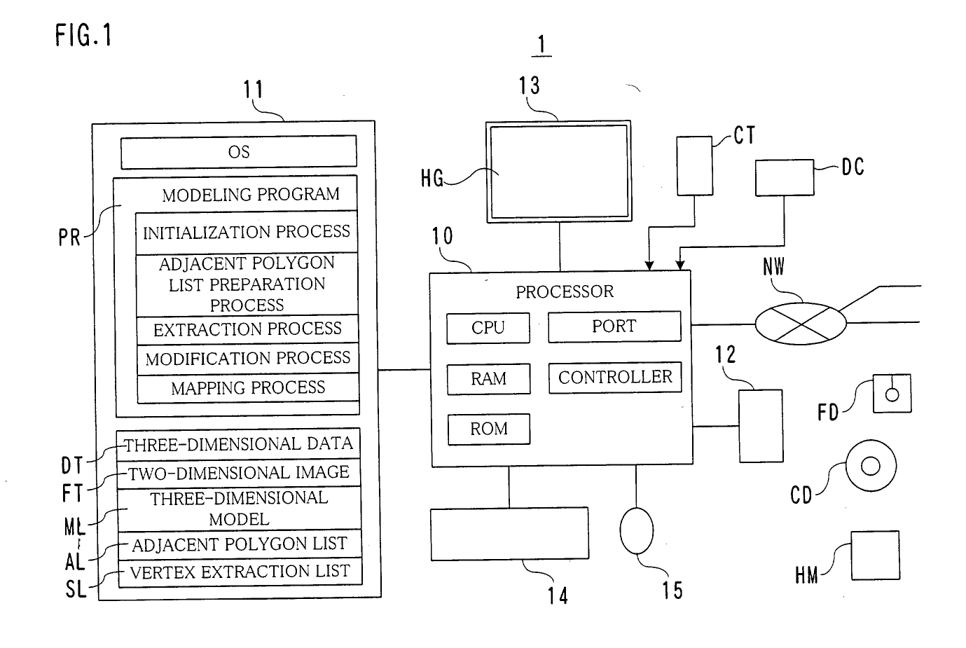

FIG. 1 is a block diagram showing an editing apparatus 1 of a three-dimensional model according to an embodiment of the present invention.

Referring to FIG. 1, the editing apparatus 1 includes a processor 10, a magnetic disc unit 11, a media drive unit 12, a display 13, a keyboard 14 and a mouse 15.

The processor 10 includes a CPU, a RAM, a ROM, a video RAM, an input and output port, various controllers and various interfaces. The CPU executes programs memorized in the RAM and the ROM to thereby realize various functions mentioned below.

The magnetic disc unit 11 stores an OS (Operating System), a modeling program PR for generating or mapping (texture mapping) a three-dimensional model (a three-dimensional shape model) ML, other programs, inputted or generated three-dimensional data (three-dimensional shape data) DT, images (texture images) FT, a generated three-dimensional model ML, an adjacent polygon list AL, a vertex extraction list SL and other data. The three-dimensional model ML includes a polygon structure list PL described hereinafter. Further, the three-dimensional model ML includes a normal three-dimensional model and a three-dimensional model edited by reducing or expanding the normal three-dimensional model. These programs and date are loaded onto the RAM in the processor 10 as required.

The modeling program PR includes programs for an initialization process, an adjacent polygon list preparation process, an extraction process, a modification process, a mapping process and other processes.

The media drive unit 12 accesses a recording medium such as a CD-ROM (CD), a floppy disk FD, a magneto-optic disk or various semiconductor memories HM for reading and writing data or programs. A driving unit to be used is selected depending on the type of the recording medium. The modeling program PR mentioned above can be installed from the recording medium. The three-dimensional data DT, the images FT and the like can be input via the recording medium, or can be downloaded via a network NW.

A display screen HG of the display 13 displays various data described above, the three-dimensional data DT, the images FT, an image being subjected to a process by the modeling program PR, the generated three-dimensional model ML such as a three-dimensional model ML1 shown in FIG. 3, for example, and other images or data.

The keyboard 14 and the mouse 15 are operated by a user to make various designations for the images FT and the three-dimensional data DT that are displayed on the display 13, and are used for inputting various data or issuing command to the processor 10.

The processor 10 can be connected to a digital camera for photographing an object at various positions around the object to obtain images FT. Further, the processor 10 can be connected to a three-dimensional measurement device for photographing an object to input three-dimensional data Dt thereof. Such a three-dimensional measurement device conducts measurement of three-dimensional data DT of an object in a non-contact manner using, for example, the light-section method. It is also possible to output data to be a source for generating the three-dimensional data DT instead of the three-dimensional data DT from the three-dimensional measurement device, then to obtain the three-dimensional data DT by performing operations in the processor 10.

Coordinates of each pixel on the images FT obtained by the digital camera are in relationship with position information of each vertex on a polygon P based on the three-dimensional data DT obtained by the three-dimensional measurement.

Additionally, the images FT may include images blended with other images at seam portions.

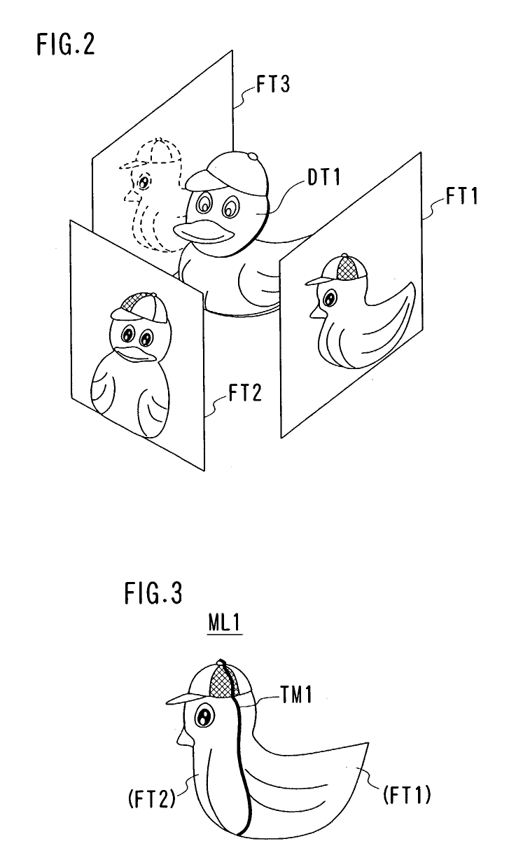

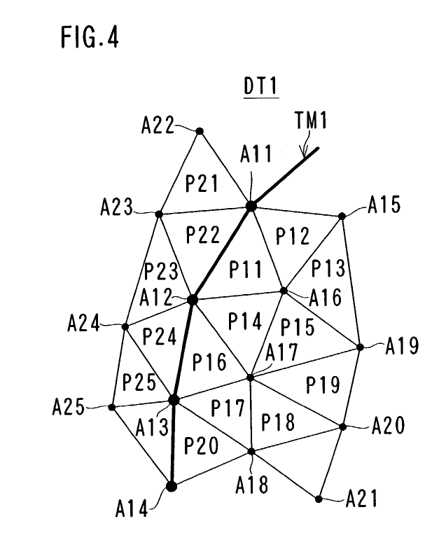

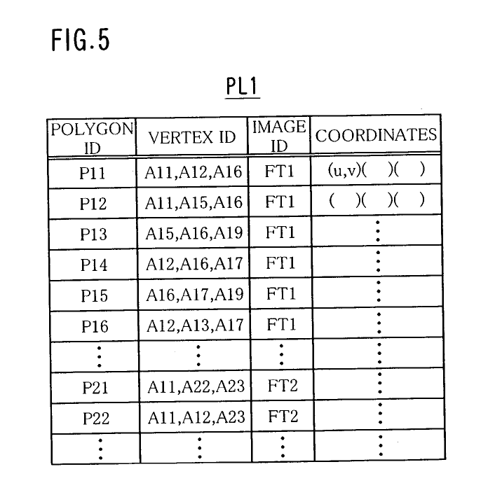

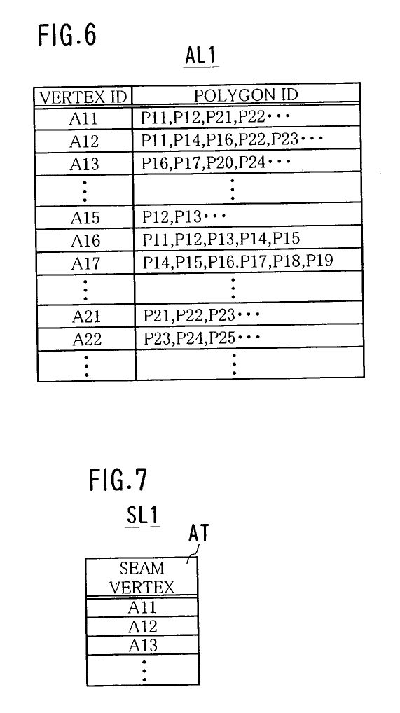

FIG. 2 shows three-dimensional data DT and images FT for mapping, FIG. 3 shows an example of a generated three-dimensional model ML1, FIG. 4 shows an example of data of a seam TM1 of the three-dimensional model ML1, FIG. 5 is a table showing an example of a polygon structure list PL1 of the three-dimensional model ML1, FIG. 6 is a table showing an example of an adjacent polygon list AL1 and FIG. 7 is a table showing an example of a vertex extraction list SL1.

As shown in FIG. 2, a plurality of images FT1, 2, 3 . . . is mapped onto three-dimensional data DT1. As a result, the three-dimensional model ML1 is created as shown in FIG. 3. The seam TM1 between the image FT1 and the image FT2 appears on the three-dimensional model ML1. Actually, however, the mapping is so carried out that the seam TM1 is not as conspicuous as FIG. 3. The images FT1, 2, 3 . . . sometimes mean image IDs. Further, the images mapped onto each of the polygons are a part of the images designated by the respective image IDs.

As shown in FIG. 4, the three-dimensional data DT1 include a plurality of vertexes A forming a plurality of polygons P. Referring to FIG. 4, the seam TM1 includes the vertexes A11, A12, A13 . . . With reference to the seam TM1, the image FT1 is mapped on the right side of the seam TM1, while the image FT2 is mapped on the left side of the seam TM1.

Referring to FIG. 5, recorded on the polygon structure list PL1 are a polygon ID for identifying each of the polygons P, a vertex ID for identifying each of the vertexes A forming each of the polygons P, an image ID for identifying one of the images FT mapped onto each of the polygons P, and coordinates of each of the vertexes A on the image.

With respect to such a three-dimensional model ML1, a process for reducing the number of vertexes A is carried out for the purpose of data reduction.

First, the adjacent polygon list AL1 as shown in FIG. 6 is prepared. Recorded on the adjacent polygon list AL1 are the vertex ID of each of the vertexes A, and the polygon ID of each of the polygons P including each of the vertexes A, as shown in FIG. 6. In other words, the adjacent polygon list AL1 indicating the polygons neighboring each of the vertexes A is prepared. Such an adjacent polygon list AL1 is made based on the three-dimensional data DT1. The polygon structure list PL1 may be referred to in the preparation of the adjacent polygon list AL1.

Then, a certain vertex A is noted and it is checked whether the identical image is allocated to all of the polygons P adjacent to the vertex A. Such checking is implemented for each of the vertexes A indicated in the adjacent polygon list AL1 by referring to the polygon structure list PL1 for all of the polygons P neighboring the vertex A, and deciding whether the identical image is mapped or not. If plural images are used for a vertex A, the vertex A is extracted as a seam vertex. The plural images mean two or more different images selected from the images FT.

Consequently, the vertexes A11, A12, A13 . . . are extracted, the vertexes being on the seam TM shown in FIG. 4. The extracted vertexes A (the seam vertexes AT) are recorded on the vertex extraction list SL1, as shown in FIG. 7.

Next, the vertex extraction list SL1 is used for a data reduction process. On this occasion, one or more of the vertexes A other than the seam vertexes AT are deleted or modified with the seam vertexes AT being maintained, i.e., without deleting or modifying the seam vertexes AT. Various known methods can be used for deleting or modifying the vertexes A.

It is assumed that the vertex A16 is deleted from the three-dimensional data DT1 shown in FIG. 4, for example.

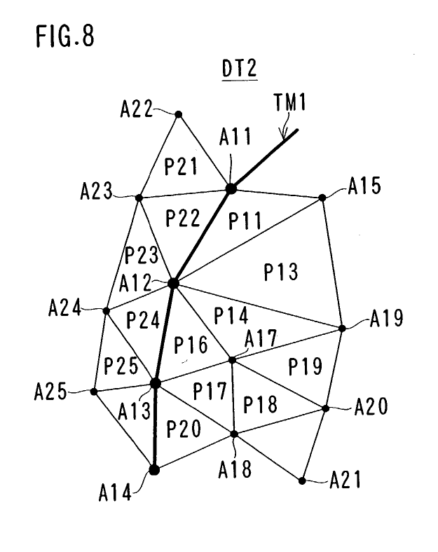

FIG. 8 shows an example of data of the seam TM1 of the three-dimensional model ML1 when the vertex A16 is deleted.

Five polygons P11, P12, P13, P14 and P15, all of which are adjacent to the vertex A16, are changed to polygons P11, P13 and P14, all of which are adjacent to the vertex A12, as a result of deletion of the vertex A16 as shown in FIG. 8. Similarly, the appropriate number of vertexes A other than the seam vertexes AT is reduced so that the polygons P are modified. Thus, three-dimensional data DT2 in which quantity of data is reduced are created.

The original images FT are mapped onto the three-dimensional data DT2 modified by the method described above. On this occasion, the seam vertexes AT are not changed, eliminating the need to change the seam TM of the images FT. It is generally unnecessary to change coordinates indicating the relationship between the images FT to be mapped and the residual vertexes A; therefore, simple processing in connection with the change of the polygons P can be conducted for completion of the mapping. Accordingly, the mapping is carried out with ease. More specifically, the mapping can be carried out without burdensome reallocation of the images FT.

Therefore, it is possible to automatically conduct the mapping onto the three-dimensional data DT2 with ease and at high speeds. Even if the mapping is carried out automatically, the seam TM on the three-dimensional data DT2 can be maintained at a good state that is the same as the case of the original three-dimensional model ML1.

In this way, the three-dimensional model ML1 is edited to make the three-dimensional model ML2 in which quantity of data is reduced.

Similarly to the case of the three-dimensional model ML1, the polygon structure list PL may be prepared for the three-dimensional model ML2.

Next, the entire edit processing in the editing apparatus 1 is described with reference to a flowchart.

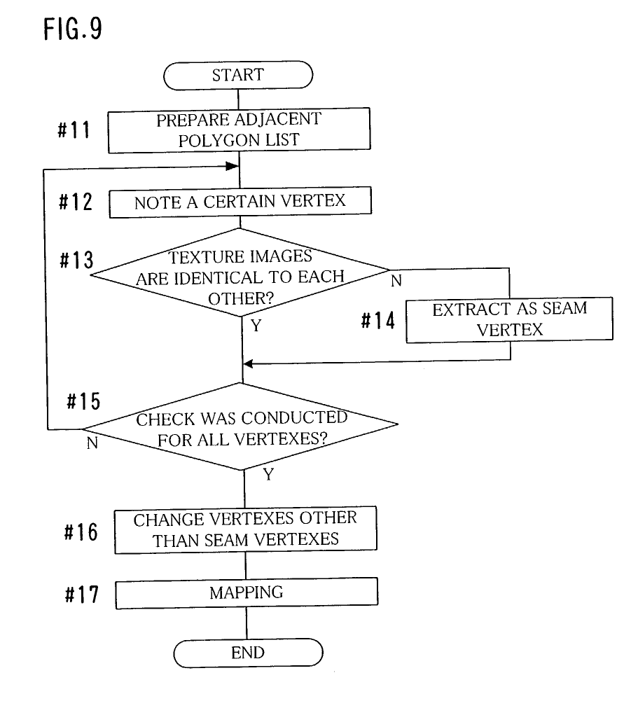

FIG. 9 is a flowchart showing the entire edit processing in the editing apparatus 1.

Referring to FIG. 9, the adjacent polygon list AL1 is prepared (#11). A certain vertex A is noted (#12) and, it is checked whether all of the images pasted as texture images are identical to each other (#13). If the images are not identical to each other (No in #13), the vertex A is extracted as a seam vertex (#14). If the check is implemented for each of the vertexes A (Yes in #15), one or more of the vertexes A other than the seam vertexes AT are changed to modify the three-dimensional data DT (#16). Mapping is conducted for the modified three-dimensional data DT (#17). Thus, the edit processing of the three-dimensional model ML is finished.

The editing apparatus 1 in the embodiments described above facilitates processing and an operation for mapping in editing a three-dimensional model so as to edit the three-dimensional model easily.

While the presently preferred embodiments of the present invention have been shown and described, it will be understood that the present invention is not limited thereto, and that various changes and modifications may be made by those skilled in the art without departing from the scope of the invention as set forth in the appended claims.

What is claimed is:

1. A method for editing a three-dimensional model in which texture images are mapped onto three-dimensional data including polygons, the method comprising:
extracting a vertex located at a seam portion between the texture images out of vertexes of the polygons as a seam vertex;
storing the extracted seam vertexes in a vertex extraction list; and
changing the vertexes other than the seam vertexes to modify the three-dimensional data without changing the seam vertexes stored in the vertex extraction list.

2. The method according to claim 1, wherein in the step of changing the vertexes, the vertexes are changed by processing for reducing the total number of vertexes in the three-dimensional data.

3. The method according to claim 1, further comprising the step of mapping the texture images onto the modified three-dimensional data.

4. The method according to claim 1, further comprising:
preparing an adjacent polygon list for indicating the polygons neighboring each of the vertexes forming the polygons; and
preparing a polygon structure list for indicating the vertexes forming each of the polygons and the texture image used in each of the polygons, wherein in the step of extracting the vertex, the texture image used in each of the polygons neighboring each of the vertexes is checked with reference to the adjacent polygon list and the polygon structure list and when the plural texture images are used for one vertex, the vertex is extracted as the seam vertex.

5. An apparatus for editing a three-dimensional model in which texture images are mapped onto three-dimensional data including polygons, the apparatus comprising:
an extraction portion for extracting a vertex located at a seam portion between the texture images out of vertexes forming the polygons as a seam vertex;
a vertex extraction list for storing the extracted seam vertexes;
a portion for changing the vertexes other than the seam vertexes to modify the three-dimensional data with the extracted seam vertexes being maintained; and
a portion for mapping the texture images onto the modified three-dimensional data.

6. The apparatus according to claim 5, wherein in the step of changing the vertexes, the vertexes are changed by processing for reducing the total number of vertexes in the three-dimensional data.

7. The apparatus according to claim 5, further comprising:
an adjacent polygon list for indicating the polygons neighboring each of the vertexes forming the polygons; and
a polygon structure list for indicating the vertexes forming each of the polygons and the texture image used in each of the polygons, wherein the extraction portion checks the texture image used in each of the polygons neighboring each of the vertexes with reference to the adjacent polygon list and the polygon structure list and when the plural texture images are used for one vertex, the extraction portion extracts the vertex as the seam vertex.

8. A computer readable medium storing a computer program for editing a three-dimensional model in which texture images are mapped onto three-dimensional data including polygons, the program making a computer perform the processing of:
extracting a vertex located at a seam portion between the texture images out of vertexes of the polygons as a seam vertex;
storing the extracted seam vertexes in a vertex extraction list; and
changing the vertexes other than the seam vertexes to modify the three-dimensional data without changing the seam vertexes stored in the vertex extraction list.

9. The computer readable medium according to claim 8, wherein in the step of changing the vertexes, the vertexes are changed by processing for reducing the total number of vertexes in the three-dimensional data.

10. The computer readable medium according to claim 8, wherein the program making the computer perform the further processing of mapping the texture images onto the modified three-dimensional data.

11. The computer readable medium according to claim 8, wherein the program making the computer perform the further processing of:
preparing an adjacent polygon list for indicating the polygons neighboring each of the vertexes forming the polygons; and
preparing a polygon structure list for indicating the vertexes forming each of the polygons and the texture image used in each of the polygons, wherein in the step of extracting the vertex, the texture image used in each of the polygons neighboring each of the vertexes is checked with reference to the adjacent polygon list and the polygon structure list and when the plural texture images are used for one vertex, the vertex is extracted as the seam vertex.
